(19) United States
(12) Patent Application Publication
(10) Pub. No.: US 2004/0129914 A1
(43) Pub. Date: Jul. 8, 2004

(54) Ball valve

(75) Inventor: Dean Shai, Taichung (TW)

Correspondence Address: David E. Dougherty, Dennison, Schultz, Dougherty & MacDonald, 1727 King Street, Suite 105, Alexandria, VA, 22314, US

(73) Assignee: LEADER TEK PRECISION INC.

(21) Appl. No.: 10/337,787

(22) Filed: Jan. 8, 2003

(51) Int. Cl. F16K 5/06

(52) U.S. Cl. 251/315.01

(57) ABSTRACT

A ball valve has a wall, and a through hole with two open ends. The wall becomes gradually smaller in thickness from a midsegment of the ball toward the two open ends of the through hole.

### FIELD OF THE INVENTION

The present invention relates to a ball valve which is strong in construction and light in weight.

### BACKGROUND OF THE INVENTION

As shown in FIGS. 1 and 2, a prior art ball valve 10 has a through hole 101 and a wall which is uniform in thickness. The prior art ball valve 10 is relatively light in weight. The uniform wall of the ball valve 10 is susceptible to being pierced or deformed in the course of forming a retaining slot 102 by milling.

As shown in FIGS. 3 and 4, a prior art ball valve 20 has a through hole 201 and a wall which is gradually thickened from the midsegment toward both ends of the through hole 201. A retaining slot 202 is formed by milling in the thickened midsegment, without penetrating the wall of the ball valve 20. However, the midsegment is thickened excessively to result in an increase in weight of the prior art ball valve 20.

The primary objective of the present invention is to provide a ball valve having a through hole and a valve wall. The valve wall located at the midsegment of the ball valve is greater in thickness than the valve wall located at both ends of the through hole. A retaining slot is formed by milling in the midsegment of the valve ball of the ball valve.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a sectional view of a prior art ball valve.

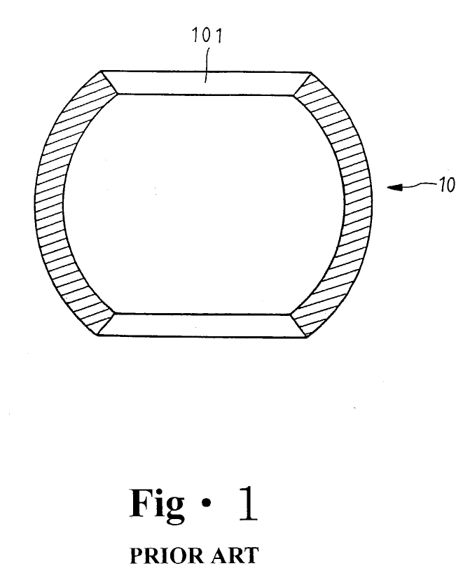

FIG. 2 shows a sectional view of a retaining slot of the prior art ball valve as shown in FIG. 1.

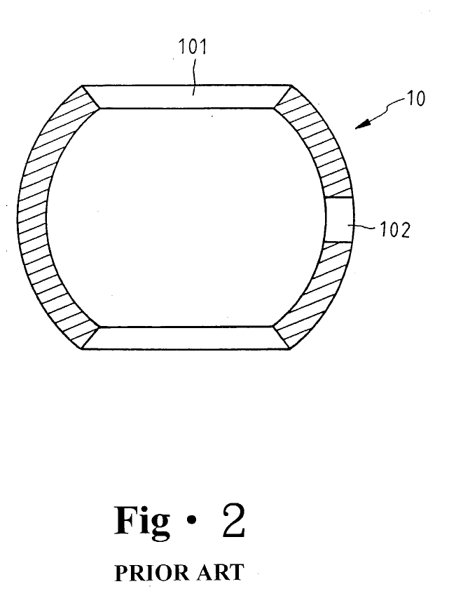

FIG. 3 shows a sectional view of another prior art ball valve.

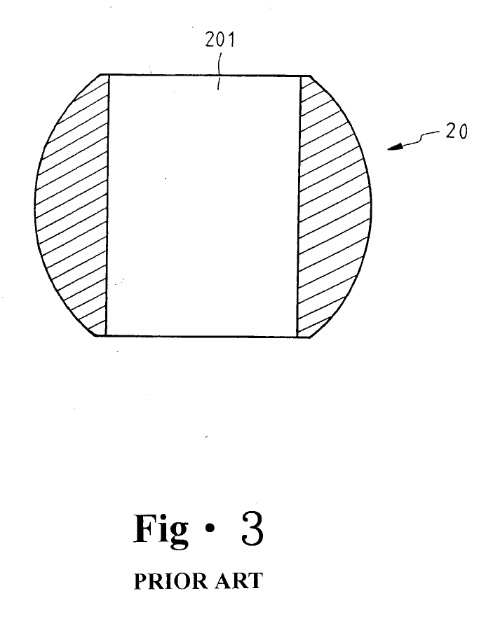

FIG. 4 shows a sectional schematic view of a retaining slot of the prior art ball valve as shown in FIG. 3

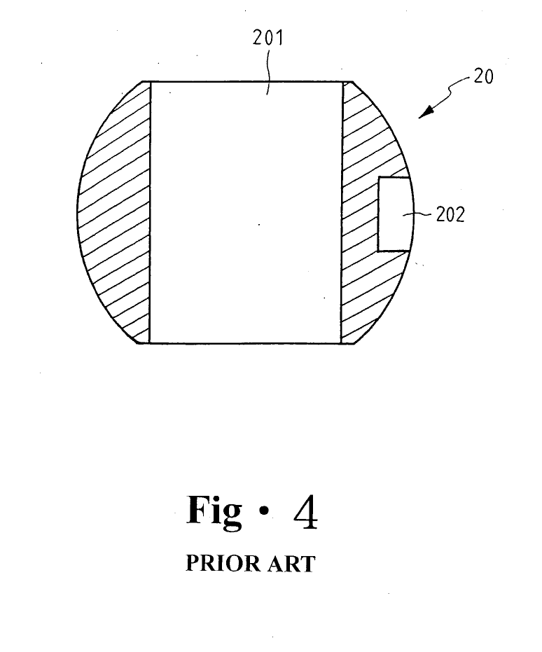

FIG. 5 shows a schematic view of a process flow of a ball valve of the present invention.

FIG. 6 shows a perspective view of the ball valve of the present invention.

FIG. 7 shows a sectional schematic view of a retaining slot of the ball valve of the present invention.

### DETAILED DESCRIPTION OF THE PREFERRED EMBODIMENT

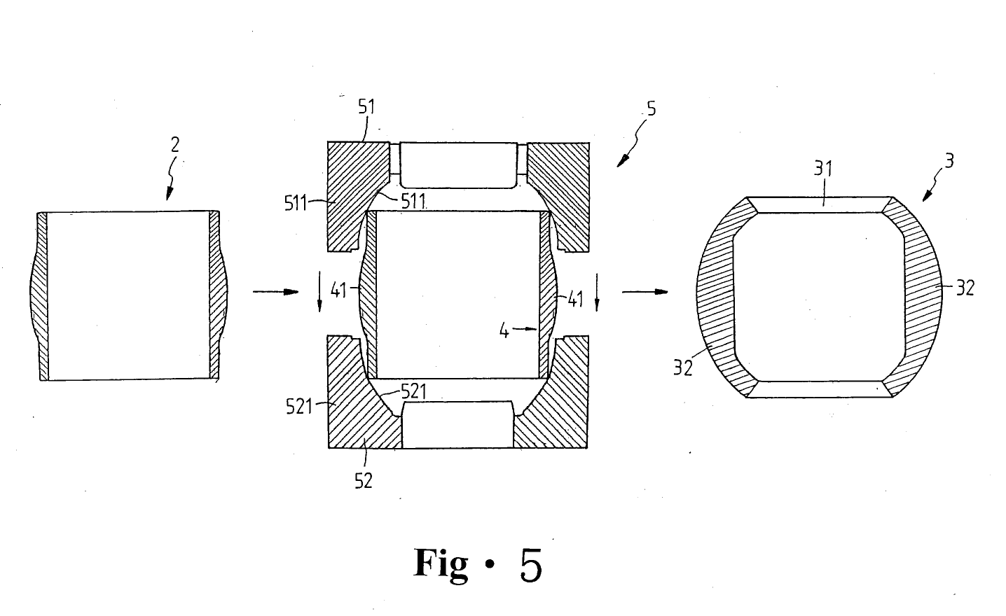

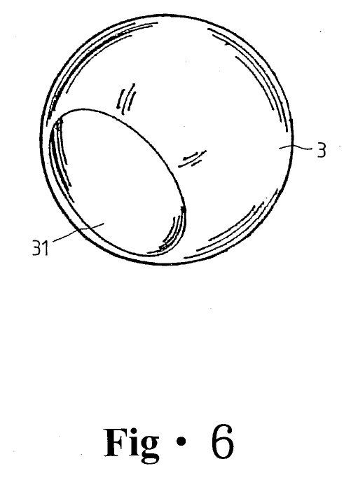

As shown in FIGS. 5 and 6, a ball valve 3 of the present invention has a through hole 31. The ball valve 3 of the present invention is made in a process in which a blank 4 is first threaded by centrifugal casting, precision casting, or sand casting, thereby resulting in formation of two protrusions 41 which are located respectively in the outer walls of the midsegment of the blank 4. The blank 4 is then arranged in a forging die 5 comprising an upper die 51 and a lower die 52. The upper die 51 is mounted on the sliding block of the forging die 5, whereas the lower die 52 is mounted on the platform of the forging die 5. The blank 4 is disposed between the upper die 51 and the lower die 52 such that the blank 4 is pressed against by the upper die 51. The upper die 51 is provided with an arcuate cavity 511 while the lower die 52 is provided with an arcuate cavity 521. As a result, when the blank 4 is pressed against by the dies, the blank 4 is formed into the ball valve 3. In light of the blank 4 being hollow, the hollow portion becomes the through hole 31. The two protrusions 41 of the blank 4 become two midsegments 32. The thickness of the midsegments 32 becomes gradually smaller toward both ends of the through hole 31.

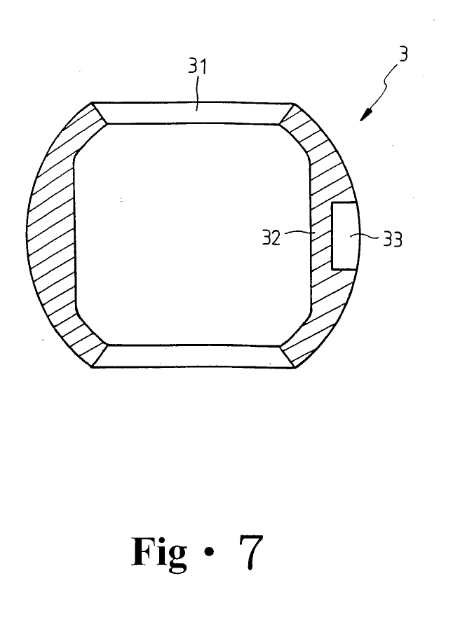

As shown in FIG. 7, the ball valve 3 is provided with a retaining slot 33 which is formed by milling in the midsegment 32. In spite of the formation of the retaining slot 33, the structural strength of the midsegment is not compromised, thanks to the midsegment 32 which has a predetermined thickness.

The ball valve 3 of the present invention is thus strong in construction and light in weight.

The embodiment of the present invention described above is to be regarded in all respects as being illustrative and nonrestrictive. Accordingly, the present invention may be embodied in other specific forms without deviating from the spirit thereof. The present invention is therefore to be limited only by the scope of the following claim.

What is claimed is:

1. A ball valve having a wall, and a through hole with two open ends; wherein said wall has a thickness which becomes gradually smaller from a midsegment of said ball valve toward said two open ends of said through hole.
